(19) United States
(12) Patent Application Publication
(10) Pub. No.: US 2008/0031325 A1
(43) Pub. Date: Feb. 7, 2008

(54) Mesh-based video compression with domain transformation

(76) Inventor: Yingyong Qi, San Diego, CA (US)

Correspondence Address: QUALCOMM INCORPORATED, 5775 MOREHOUSE DR., SAN DIEGO, CA, 92121, US

(21) Appl. No.: 11/499,275

(22) Filed: Aug. 3, 2006

(51) Int. Cl. H04B 1/66

(52) U.S. Cl. 375/240.09; 375/240.27

(57) ABSTRACT

Techniques for performing mesh-based video compression/decompression with domain transformation are described. A video encoder partitions an image into meshes of pixels, processes the meshes of pixels to obtain blocks of prediction errors, and codes the blocks of prediction errors to generate coded data for the image. The meshes may have arbitrary polygonal shapes and the blocks may have a predetermined shape, e.g., square. The video encoder may process the meshes of pixels to obtain meshes of prediction errors and may then transform the meshes of prediction errors to the blocks of prediction errors. Alternatively, the video encoder may transform the meshes of pixels to blocks of pixels and may then process the blocks of pixels to obtain the blocks of prediction errors. The video encoder may also perform mesh-based motion estimation to determine reference meshes used to generate the prediction errors.

### BACKGROUND

I. Field

The present disclosure relates generally to data processing, and more specifically to techniques for performing video compression.

II. Background

Video compression is widely used for various applications such as digital television, video broadcast, videoconference, video telephony, digital video disc (DVD), etc. Video compression exploits similarities between successive frames of video to significantly reduce the amount of data to send or store. This data reduction is especially important for applications in which transmission bandwidth and/or storage space is limited.

Video compression is typically achieved by partitioning each frame of video into square blocks of picture elements (pixels) and processing each block of the frame. The processing for a block of a frame may include identifying another block in another frame that closely resembles the block being processed, determining the difference between the two blocks, and coding the difference. The difference is also referred to as prediction errors, texture, prediction residue, etc. The process of finding another closely matching block, or a reference block, is often referred to as motion estimation. The terms “motion estimation” and “motion prediction” are often used interchangeably. The coding of the difference is also referred to as texture coding and may be achieved with various coding tools such as discrete cosine transform (DCT).

Block-based motion estimation is used in almost all widely accepted video compression standards such as MPEG-2, MPEG-4, H-263 and H-264, which are well known in the art. With block-based motion estimation, the motion of a block of pixels is characterized or defined by a small set of motion vectors. A motion vector indicates the vertical and horizontal displacements between a block being coded and a reference block. For example, when one motion vector is defined for a block, all pixels in the block are assumed to have moved by the same amount, and the motion vector defines the translational motion of the block. Block-based motion estimation works well when the motion of a block or sub-block is small, translational, and uniform across the block or sub-block. However, actual video often does not comply with these conditions. For example, facial or lip movements of a person during a videoconference often include rotation and deformation as well as translational motion. In addition, discontinuity of motion vectors of neighboring blocks may create annoying blocking effects in low bit-rate applications. Block-based motion estimation does not provide good performance in many scenarios.

### SUMMARY

Techniques for performing mesh-based video compression/decompression with domain transformation are described herein. The techniques may provide improved performance over block-based video compression/decompression.

In an embodiment, a video encoder partitions an image or frame into meshes of pixels, processes the meshes of pixels to obtain blocks of prediction errors, and codes the blocks of prediction errors to generate coded data for the image. The meshes may have arbitrary polygonal shapes and the blocks may have a predetermined shape, e.g., a square of a predetermined size. The video encoder may process the meshes of pixels to obtain meshes of prediction errors and may then transform the meshes of prediction errors to the blocks of prediction errors. Alternatively, the video encoder may transform the meshes of pixels to blocks of pixels and may then process the blocks of pixels to obtain the blocks of prediction errors. The video encoder may also perform mesh-based motion estimation to determine reference meshes used to generate the prediction errors.

In an embodiment, a video decoder obtain blocks of prediction errors based on coded data for an image, processes the blocks of prediction errors to obtain meshes of pixels, and assembles the meshes of pixels to reconstruct the image. The video decoder may transform the blocks of prediction errors to meshes of prediction errors, derive predicted meshes based on motion vectors, and derive the meshes of pixels based on the meshes of prediction errors and the predicted meshes. Alternatively, the video decoder may derive predicted blocks based on motion vectors, derive the blocks of pixels based on the blocks of prediction errors and the predicted blocks, and transform the blocks of pixels to the meshes of pixels.

Various aspects and embodiments of the disclosure are described in further detail below.

### BRIEF DESCRIPTION OF THE DRAWINGS

Aspects and embodiments of the disclosure will become more apparent from the detailed description set forth below when taken in conjunction with the drawings in which like reference characters identify correspondingly throughout.

FIG. 1 shows a mesh-based video encoder with domain transformation.

FIG. 2 shows a mesh-based video decoder with domain transformation.

FIG. 3 shows an exemplary image that has been partitioned into meshes.

FIGS. 4A and 4B illustrate motion estimation of a target mesh.

FIG. 5 illustrates domain transformation between two meshes and a block.

FIG. 6 shows domain transformation for all meshes of a frame.

FIG. 7 shows a process for performing mesh-based video compression with domain transformation.

FIG. 8 shows a process for performing mesh-based video decompression with domain transformation.

FIG. 9 shows a block diagram of a wireless device.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

Techniques for performing mesh-based video compression/decompression with domain transformation are described herein. Mesh-based video compression refers to compression of video with each frame being partitioned into meshes instead of blocks. In general, the meshes may be of any polygonal shape, e.g., triangles, quadrilaterals, pentagons, etc. In an embodiment that is described in detail below, the meshes are quadrilaterals (QUADs), with each QUAD having four vertices. Domain transformation refers to the transformation of a mesh to a block, or vice versa. A block has a predetermined shape and is typically a square but may also be a rectangle. The techniques allow for use of mesh-based motion estimation, which may have improved performance over block-based motion estimation. The domain transformation enables efficient texture coding for meshes by transforming these meshes to blocks and enabling use of coding tools designed for blocks.

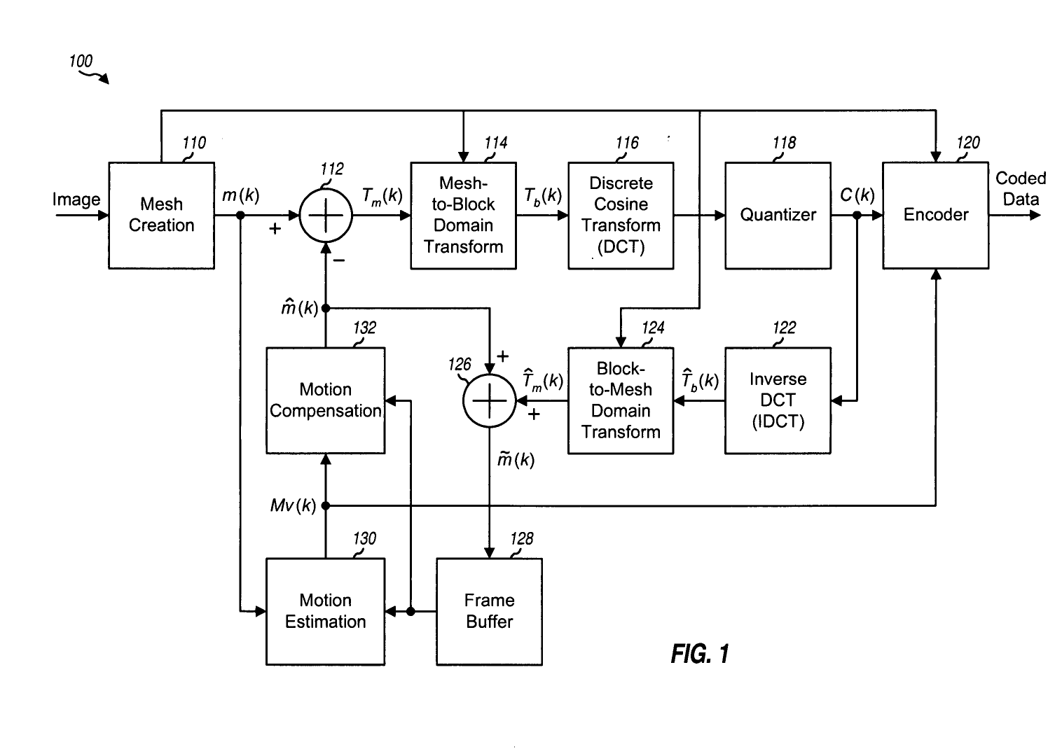

FIG. 1 shows a block diagram of an embodiment of a mesh-based video encoder 100 with domain transformation. Within video encoder 100, a mesh creation unit 110 receives a frame of video and partitions the frame into meshes of pixels. The terms “frame” and “image” are often used interchangeably. Each mesh of pixels in the frame may be coded as described below.

A summer 112 receives a mesh of pixels to code, which is referred to as a target mesh m(k), where k identifies a specific mesh within the frame. In general, k may be a coordinate, an index, etc. Summer 112 also receives a predicted mesh \hat{m}(k), which is an approximation of the target mesh. Summer 110 subtracts the predicted, mesh from the target mesh and provides a mesh of prediction errors, Tₘ(k). The prediction errors are also referred to as texture, prediction residue, etc.

A unit 114 performs mesh-to-block domain transformation on the mesh of prediction errors, Tₘ(k), and provides a block of prediction errors, T_{b}(k), as described below. The block of prediction errors may be processed using various coding tools for blocks. In the embodiment shown in FIG. 1, a unit 116 performs DCT on the block of prediction errors and provides a block of DCT coefficients. A quantizer 118 quantizes the DCT coefficients and provides quantized coefficients C(k).

A unit 122 performs inverse DCT (IDCT) on the quantized coefficients and provides a reconstructed block of prediction errors, \hat{T}_{b}(k). A unit 124 performs block-to-mesh domain transformation on the reconstructed block of prediction errors and provides a reconstructed mesh of prediction errors, \hat{T}ₘ(k). \hat{T}ₘ(k) and \hat{T}_{b}(k) are approximations of Tₘ(k) and T_{b}(k), respectively, and contain possible errors from the various transformations and quantization. A summer 126 sums the predicted mesh \hat{m}(k) with the reconstructed mesh of prediction errors and provides a decoded mesh \tilde{m}(k) to a frame buffer 128.

A motion estimation unit 130 estimates the affine motion of the target mesh, as described below, and provides motion vectors Mv(k) for the target mesh. Affine motion may comprise translational motion as well as rotation, shearing, scaling, deformation, etc. The motion vectors convey the affine motion of the target mesh relative to a reference mesh. The reference mesh may be from a prior frame or a future frame. A motion compensation unit 132 determines the reference mesh based on the motion vectors and generates the predicted mesh for summers 112 and 126. The predicted mesh has the same shape as the target mesh whereas the reference mesh may have the same shape as the target mesh or a different shape.

An encoder 120 receives various information for the target mesh, such as the quantized coefficients from quantizer 118, the motion vectors from unit 130, the target mesh representation from unit 110, etc. Unit 110 may provide mesh representation information for the current frame, e.g., the coordinates of all meshes in the frame and an index list indicating the vertices of each mesh. Encoder 120 may perform entropy coding (e.g., Huffinan coding) on the quantized coefficients to reduce the amount of data to send. Encoder 120 may compute the norm of the quantized coefficients for each block and may code the block only if the norm exceeds a threshold, which may indicate that sufficient difference exists between the target mesh and the reference mesh. Encoder 120 may also assemble data and motion vectors for the meshes of the frame, perform formatting for timing alignment, insert header and syntax, etc. Encoder 120 generates data packets or a bit stream for transmission and/or storage.

A target mesh may be compared against a reference mesh, and the resultant prediction errors may be coded, as described above. A target mesh may also be coded directly, without being compared against a reference mesh, and may then be referred to as an intra-mesh. Intra-meshes are typically sent for the first frame of video and are also sent periodically to prevent accumulation of prediction errors.

FIG. 1 shows an exemplary embodiment of a mesh-based video encoder with domain transformation. In this embodiment, units 110, 112, 126, 130 and 132 operate on meshes, which may be QUADs having arbitrary shapes and sizes depending on the image being coded. Units 116, 118, 120 and 122 operate on blocks of fixed size. Unit 114 performs mesh-to-block domain transformation, and unit 124 performs block-to-mesh domain transformation. Pertinent units of video encoder 100 are described in detailed below.

In another embodiment of a mesh-based video encoder, the target mesh is domain transformed to a target block, and the reference mesh is also domain transformed to a predicted block. The predicted block is subtracted from the target block to obtain a block of prediction errors, which may be processed using block-based coding tools. Mesh-based video encoding may also be performed in other manners with other designs.

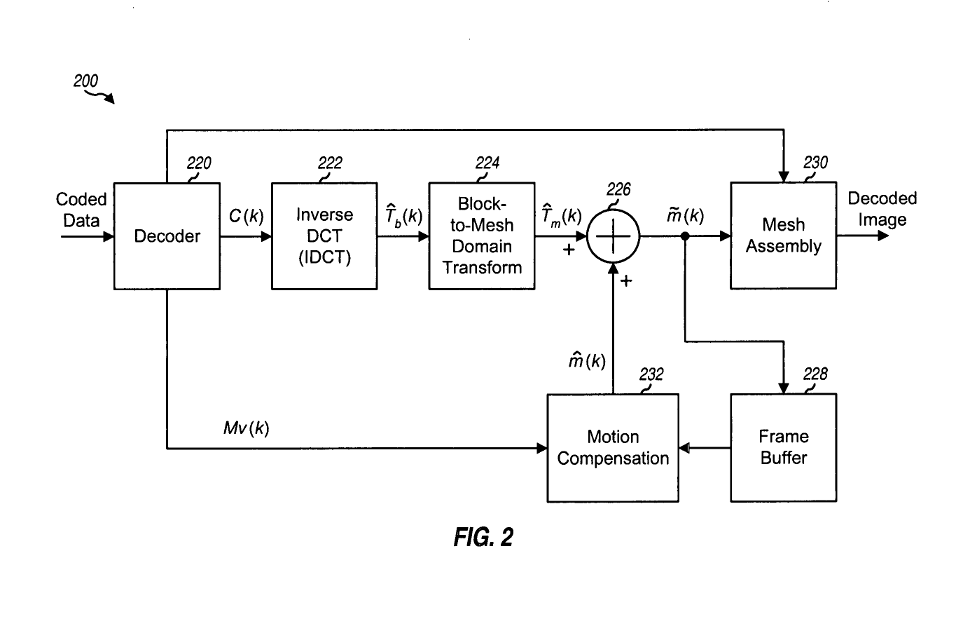

FIG. 2 shows a block diagram of an embodiment of a mesh-based video decoder 200 with domain transformation. Video decoder 200 may be used for video encoder 100 in FIG. 1. Within video decoder 200, a decoder 220 receives packets or a bit stream of coded data from video encoder 100 and decodes the packets or bit stream in a manner complementary to the coding performed by encoder 120. Each mesh of an image may be decoded as described below.

Decoder 220 provides the quantized coefficients C(k), the motion vectors Mv(k), and mesh representation for a target mesh being decoded. A unit 222 performs IDCT on the quantized coefficients and provides a reconstructed block of prediction errors, \hat{T}_{b}(k). A unit 224 performs block-to-mesh domain transformation on the reconstructed block of prediction errors and provides a reconstructed mesh of prediction errors, \hat{T}ₘ(k). A summer 226 sums the reconstructed mesh of prediction errors and a predicted mesh \hat{m}(k) from a motion compensation unit 232 and provides a decoded mesh \tilde{m}(k) to a frame buffer 228 and a mesh assembly unit 230. Motion compensation unit 232 determines a reference mesh from frame buffer 228 based on the motion vectors Mv(k) for the target mesh and generates the predicted mesh \hat{m}(k). Units 222, 224, 226, 228 and 232 operate in similar manner as units 122, 124, 126, 128 and 132, respectively, in FIG. 1. Unit 230 receives and assembles the decoded meshes for a frame of video and provides a decoded frame.

The video encoder may transform target meshes and predicted meshes to blocks and may generate blocks of prediction errors based on the target and predicted blocks. In this case, the video decoder would sum the reconstructed blocks of prediction errors and predicted blocks to obtain decoded blocks and would then perform block-to-mesh domain transformation on the decoded blocks to obtain decoded meshes. Domain transformation unit 224 would be moved after summer 226, and motion compensation unit 232 would provide predicted blocks instead of predicted meshes.

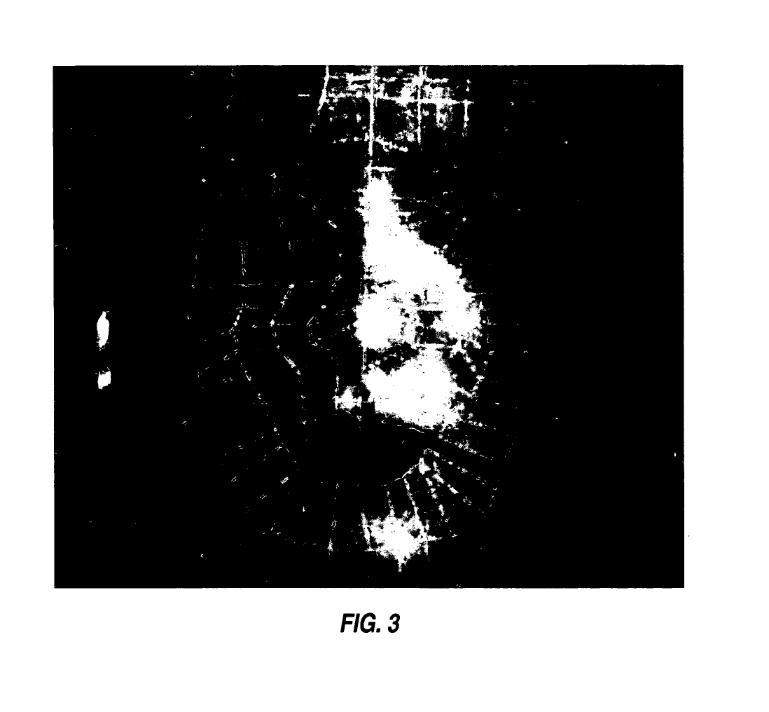

FIG. 3 shows an exemplary image or frame that has been partitioned into meshes. In general, a frame may be partitioned into any number of meshes. These meshes may be of different shapes and sizes, which may be determined by the content of the frame, as illustrated in FIG. 3.

The process of partitioning a frame into meshes is referred to as mesh creation. Mesh creation may be performed in various manners. In an embodiment, mesh creation is performed with spatial or spatio-temporal segmentation, polygon approximation, and triangulation, which are briefly described below.

Spatial segmentation refers to segmentation of a frame into regions based on the content of the frame. Various algorithms known in the art may be used to obtain reasonable image segmentation. For example, a segmentation algorithm referred to as JSEG and described by Deng et al. in “Color Image Segmentation,” Proc. IEEE CSCC Visual Pattern Recognition (CVPR), vol. 2, pp. 446-451, June 1999, may be used to achieve spatial segmentation. As another example, a segmentation algorithm described by Black et aL in “The Robust Estimation of Multiple Motions: Parametric and Piecewise-Smooth,” Comput. Vis. Image Underst., 63, (1), pp. 75-104, 1996, may be used to estimate dense optical flow between two frames.

Spatial segmentation of a frame may be performed as follows.
Perform initial spatial segmentation of the frame using JSEG.
Compute dense optical flow (pixel motion) between two neighboring frames.
Split a region of the initial spatial segmentation into two smaller regions if the initial region has high motion vector variance.
Merge two regions of the initial spatial segmentation into one region if the initial regions have similar mean motion vectors and their joint variance is relatively low.

### The split and merge steps are used to refine the initial spatial segmentation based on pixel motion properties.

Polygon approximation refers to approximation of each region of the frame with a polygon. An approximation algorithm based on common region boundaries may be used for polygon approximation. This algorithm operates as follows.
For each pair of neighboring regions, find their common boundary, e.g., a curved line along their common border with endpoints Pₐ and P_{b}.
Initially, the two endpoints Pₐ and P_{b} are polygon approximation points for the curved boundary between the two regions.
A point Pₙ on the curved boundary with the maximum perpendicular distance from a straight line connecting the endpoints Pₐ and P_{b} is determined. If this distance exceeds a threshold dₘₐₓ, then a new polygon approximation point is selected at point Pₙ. The process is then applied recursively to the curve boundary from Pₐ to Pₙ and also the curve boundary from Pₙ , to P_{b}.
If no new polygon approximation point is added, then the straight line from Pₐ to P_{b} is an adequate approximation of the curved boundary between these two endpoints.
A large value of dₘₐₓ, may be used initially. Once all boundaries have been approximated with segments, dₘₐₓ may be reduced (e.g., halved), and the process may be repeated. This may continue until dₘₐₓ is small enough to achieve sufficiently accurate polygon approximation.

Triangulation refers to creation of triangles and ultimately QUAD meshes within each polygon. Triangulation may be performed as described by J. R. Shewchuk in “Triangle: Engineering a 2D Quality Mesh Generator and Delaunay Triangulator,” Appl. Comp. Geom.: Towards Geom. Engine, ser. Lecture Notes in Computer Science, 1148, pp. 203-222, May 1996. This paper describes generating a Delaunay mesh inside each polygon and forcing the edges of the polygon to be part of the mesh. The polygon boundaries are specified as segments within a planar straight-line graph and, where possible, triangles are created with all angles larger than 20 degrees. Up to four interior nodes per polygon may be added during the triangulation process. The neighboring triangles may then be combined using a merge algorithm to form QUAD meshes. The result of the triangulation is a frame partitioned into meshes.

Referring back to FIG. 1, motion estimation unit 130 may estimate motion parameters for each mesh of the current frame. In an embodiment, the motion of each mesh is estimated independently so that the motion estimation of one mesh does not influence the motion estimation of neighbor meshes. In an embodiment, the motion estimation of a mesh is performed in a two-step process. The first step estimates translational motion of the mesh. The second step estimates other types of motion of the mesh.

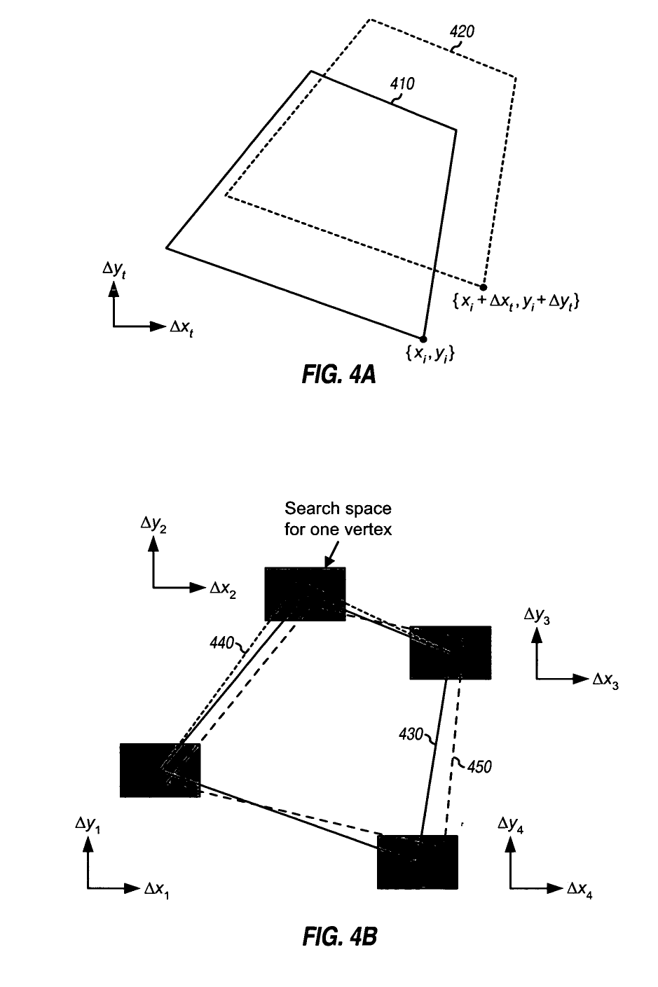

FIG. 4A illustrates estimation of translational motion of a target mesh 410. Target mesh 410 of the current frame is matched against a candidate mesh 420 in another frame either before or after the current frame. Candidate mesh 420 is translated or shifted from target mesh 410 by (Δx,Δy), where Δx denotes the amount of translation in the horizontal or x direction and Δy denotes the amount of translation in the vertical or y direction. The matching between meshes 410 and 420 may be performed by calculating a metric between the (e.g., color or grey-scale) intensities of the pixels in target mesh 410 and the intensities of the corresponding pixels in candidate mesh 420. The metric may be mean square error (MSE), mean absolute difference, or some other appropriate metric.

Target mesh 410 may be matched against a number of candidate meshes at different (Δx,Δy) translations in a prior frame before the current frame and/or a future frame after the current frame. Each candidate mesh has the same shape as the target mesh. The translation may be restricted to a particular search area. A metric may be computed for each candidate mesh, as described above for candidate mesh 420. The shift that results in the best metric (e.g., the smallest MSE) is selected as the translational motion vector (Δxₜ,Δyₜ) for the target mesh. The candidate mesh with the best metric is referred to as the selected mesh, and the frame with the selected mesh is referred to as the reference frame. The selected mesh and the reference frame are used in the second stage. The translational motion vector may be calculated to integer pixel accuracy. Sub-pixel accuracy may be achieved in the second step.

In the second step, the selected mesh is warped to determine whether a better match to the target mesh can be obtained. The warping may be used to determine motion due to rotation, shearing, deformation, scaling, etc. In an embodiment, the selected mesh is warped by moving one vertex at a time while keeping the other three vertices fixed. Each vertex of the target mesh is related to a corresponding vertex of a warped mesh, as follows:

$$[ \begin{matrix}{x}_{i}^{′} \\ {y}_{i}^{′}\end{matrix} ] = [ \begin{matrix}{x}_{i} \\ {y}_{i}\end{matrix} ] + [ \begin{matrix}Δ {x}_{t} \\ Δ {y}_{t}\end{matrix} ] + [ \begin{matrix}Δ {x}_{i} \\ Δ {y}_{i}\end{matrix} ] , \\ for i ∈ \{ 1 , 2 , 3 , 4 \} , \qquad Eq ( 1 )$$

where i is an index for the four vertices of the meshes,

(Δxₜ,Δyₜ) is the translational motion vector obtained in the first step,

(Δxᵢ,Δyᵢ) is the additional displacement of vertex i of the warped mesh,

(xᵢ,yᵢ) is the coordinate of vertex i of the target mesh, and

(x′ᵢ,y′ᵢ) is the coordinate of vertex i of the warped mesh.

For each pixel or point in the target mesh, the corresponding pixel or point in the warped mesh may be determined based on an 8-parameter bilinear transform, as follows:

$$[ \begin{matrix}{x}^{′} \\ {y}^{′}\end{matrix} ] = [ \begin{matrix}{a}_{1} & {a}_{2} & {a}_{3} & {a}_{4} + Δ {x}_{t} \\ {a}_{5} & {a}_{6} & {a}_{7} & {a}_{8} + Δ {y}_{t}\end{matrix} ] \cdot [ \begin{matrix}xy \\ x \\ y \\ 1\end{matrix} ] , \qquad Eq ( 2 )$$

where a₁, a₂, . . . , a₈ are eight bilinear transform coefficients,

(x,y) is the coordinate of a pixel in the target mesh, and

(x′,y′) is the coordinate of the corresponding pixel in the warped mesh.

To determine the bilinear transform coefficients, equation (2) may be computed for the four vertices and expressed as follows:

$$[ \begin{matrix}{x}_{1}^{′} \\ {y}_{1}^{′} \\ {x}_{2}^{′} \\ {y}_{2}^{′} \\ {x}_{3}^{′} \\ {y}_{3}^{′} \\ {x}_{4}^{′} \\ {y}_{4}^{′}\end{matrix} ] = [ \begin{matrix}{x}_{1} {y}_{1} & {x}_{1} & {y}_{1} & 1 & 0 & 0 & 0 & 0 \\ 0 & 0 & 0 & 0 & {x}_{1} {y}_{1} & {x}_{1} & {y}_{1} & 1 \\ {x}_{2} {y}_{2} & {x}_{2} & {y}_{2} & 1 & 0 & 0 & 0 & 0 \\ 0 & 0 & 0 & 0 & {x}_{2} {y}_{2} & {x}_{2} & {y}_{2} & 1 \\ {x}_{3} {y}_{3} & {x}_{3} & {y}_{3} & 1 & 0 & 0 & 0 & 0 \\ 0 & 0 & 0 & 0 & {x}_{3} {y}_{3} & {x}_{3} & {y}_{3} & 1 \\ {x}_{4} {y}_{4} & {x}_{4} & {y}_{4} & 1 & 0 & 0 & 0 & 0 \\ 0 & 0 & 0 & 0 & {x}_{4} {y}_{4} & {x}_{4} & {y}_{4} & 1\end{matrix} ] \cdot [ \begin{matrix}{a}_{1} \\ {a}_{2} \\ {a}_{3} \\ {a}_{4} + Δ {x}_{t} \\ {a}_{5} \\ {a}_{6} \\ {a}_{7} \\ {a}_{8} + Δ {y}_{t}\end{matrix} ] . \qquad Eq ( 3 )$$

The coordinates (xᵢ,yᵢ) and (x′ᵢ,y′ᵢ) of the four vertices of the target mesh and the warped mesh are known. The coordinate (x′ᵢ,y′ᵢ) includes the additional displacement (Δxᵢ,Δyᵢ) from the warping, as shown in equation (1).

Equation (3) may be expressed in matrix form as follows:

x=B·a, Eq (4)

where x is an 8×1 vector of coordinates for the four vertices of the warped mesh,

B is an 8×8 matrix to the right of the equality in equation (3), and

a is an 8×1 vector of bilinear transform coefficients.

The bilinear transform coefficients may be obtained as follows:

a=B₋₁·x. Eq (5)

Matrix B⁻¹ is computed only once for the target mesh in the second step. This is because matrix B contains the coordinates of the vertices of the target mesh, which do not vary during the warping.

FIG. 4B illustrates estimation of non-translational motion of the target mesh in the second step. Each of the four vertices of a selected mesh 430 may be moved within a small search area while keeping the other three vertices fixed. A warped mesh 440 is obtained by moving one vertex by (Δxᵢ,Δyᵢ) with the other three vertices fixed. The target mesh (not shown in FIG. 4B) is matched against warped mesh 440 by (a) determining the pixels in warped mesh 440 corresponding to the pixels in the target mesh, e.g., as shown in equation (2), and (b) calculating a metric based on the intensities of the pixels in the target mesh and the intensities of the corresponding pixels in warped mesh 440. The metric may be MSE, mean absolute difference, or some other appropriate metric.

For a given vertex, the target mesh may be matched against a number of warped meshes obtained with different (Δxᵢ,Δyᵢ) displacements of that vertex. A metric may be computed for each warped mesh. The (Δxᵢ,Δyᵢ) displacement that results in the best metric (e.g., the smallest MSE) is selected as the additional motion vector (Δxᵢ,Δyᵢ) for the vertex. The same processing may be performed for each of the four vertices to obtain four additional motion vectors for the four vertices.

In the embodiment shown in FIGS. 4A and 4B, the motion vectors for the target mesh comprise the translational motion vector (Δxₜ,Δyₜ) and the four additional motion vectors (Δxᵢ,Δyᵢ), for i=1, 2, 3, 4, for the four vertices. These motion vectors may be combined, e.g., (Δx′ᵢ,Δy′ᵢ)=(Δxₜ,Δyₜ)+(Δxᵢ,Δyᵢ), to obtain four affine motion vectors (Δx′ᵢ,Δy′ᵢ), for i=1, 2, 3, 4, for the four vertices of the target mesh. The affine motion vectors convey various types of motion.

The affine motion of the target mesh may be estimated with the two-step process described above, which may reduce computation. The affine motion may also be estimated in other manners. In another embodiment, the affine motion is estimated by first estimating the translational motion, as described above, and then moving multiple (e.g., all four) vertices simultaneously across a search space. In yet another embodiment, the affine motion is estimated by moving one vertex at a time, without first estimating the translational motion. In yet another embodiment, the affine motion is estimated by moving all four vertices simultaneously, without first estimating the translational motion. In general, moving one vertex at a time may provide reasonably good motion estimation with less computation than moving all four vertices simultaneously.

Motion compensation unit 132 receives the affine motion vectors from motion estimation unit 130 and generates the predicted mesh for the target mesh. The affine motion vectors define the reference mesh for the target mesh. The reference mesh may have the same shape as the target mesh or a different shape. Unit 132 may perform mesh-to-mesh domain transformation on the reference mesh with a set of bilinear transform coefficients to obtain the predicted mesh having the same shape as the target mesh.

Domain transformation unit 114 transforms a mesh with an arbitrary shape to a block with a predetermined shape, e.g., square or rectangle. The mesh may be mapped to a unit square block using the 8-coefficient bilinear transform, as follows:

$$[ \begin{matrix}0 \\ 0 \\ 0 \\ 1 \\ 1 \\ 1 \\ 1 \\ 0\end{matrix} ] = [ \begin{matrix}{x}_{1} {y}_{1} & {x}_{1} & {y}_{1} & 1 & 0 & 0 & 0 & 0 \\ 0 & 0 & 0 & 0 & {x}_{1} {y}_{1} & {x}_{1} & {y}_{1} & 1 \\ {x}_{2} {y}_{2} & {x}_{2} & {y}_{2} & 1 & 0 & 0 & 0 & 0 \\ 0 & 0 & 0 & 0 & {x}_{2} {y}_{2} & {x}_{2} & {y}_{2} & 1 \\ {x}_{3} {y}_{3} & {x}_{3} & {y}_{3} & 1 & 0 & 0 & 0 & 0 \\ 0 & 0 & 0 & 0 & {x}_{3} {y}_{3} & {x}_{3} & {y}_{3} & 1 \\ {x}_{4} {y}_{4} & {x}_{4} & {y}_{4} & 1 & 0 & 0 & 0 & 0 \\ 0 & 0 & 0 & 0 & {x}_{4} {y}_{4} & {x}_{4} & {y}_{4} & 1\end{matrix} ] \cdot [ \begin{matrix}{c}_{1} \\ {c}_{2} \\ {c}_{3} \\ {c}_{4} \\ {c}_{5} \\ {c}_{6} \\ {c}_{7} \\ {c}_{8}\end{matrix} ] , \qquad Eq ( 6 )$$

where c₁, c₂, . . . , c₈ are eight coefficients for the mesh-to-block domain transformation.

Equation (6) has the same form as equation (3). However, in the vector to the left of the equality, the coordinates of the four mesh vertices in equation (3) are replaced with the coordinates of the four block vertices in equation (6), so that (u₁, v₁)=(0,0) replaces (x′₁,y′₁), (u₂,v₂)=(0,1) replaces (x′₂,y′₂), (u₃,v₃)=(1,1) replaces (x′₃,y′₃), and (u₄,v₄)=(1,0) replaces (x′₄,y′₄). Furthermore, the vector of coefficients a₁, a₂, . . . , a₈ in equation (3) is replaced with the vector of coefficients c₁, c₂, . . . , c₈ in equation (6). Equation (6) maps the target mesh to the unit square block using coefficients c₁, c₂, . . . , c₈.

Equation (6) may be expressed in matrix form as follows:

u=B·c , Eq (7)

where u is an 8×1 vector of coordinates for the four vertices of the block, and
c is an 8×1 vector of coefficients for the mesh-to-block domain transformation.

The domain transformation coefficients c may be obtained as follows:

c=B⁻¹·u, Eq (8)

where matrix B⁻¹ is computed during motion estimation.

The mesh-to-block domain transformation may be performed as follows:

$$[ \begin{matrix}u \\ v\end{matrix} ] = [ \begin{matrix}{c}_{1} & {c}_{2} & {c}_{3} & {c}_{4} \\ {c}_{5} & {c}_{6} & {c}_{7} & {c}_{8}\end{matrix} ] \cdot [ \begin{matrix}xy \\ x \\ y \\ 1\end{matrix} ] . \qquad Eq ( 9 )$$

Equation (9) maps a pixel or point at coordinate (x,y) in the target mesh to a corresponding pixel or point at coordinate (u,v) in the block. Each of the pixels in the target mesh may be mapped to a corresponding pixel in the block. The coordinates of the mapped pixels may not be integer values. Interpolation may be performed on the mapped pixels in the block to obtain pixels at integer coordinates. The block may then be processed using block-based coding tools.

Domain transformation unit 124 transforms a unit square block to a mesh using the 8-coefficient bilinear transform, as follows:

$$[ \begin{matrix}{x}_{1} \\ {y}_{1} \\ {x}_{2} \\ {y}_{2} \\ {x}_{3} \\ {y}_{3} \\ {x}_{4} \\ {y}_{4}\end{matrix} ] = [ \begin{matrix}0 & 0 & 0 & 1 & 0 & 0 & 0 & 0 \\ 0 & 0 & 0 & 0 & 0 & 0 & 0 & 1 \\ 0 & 0 & 1 & 1 & 0 & 0 & 0 & 0 \\ 0 & 0 & 0 & 0 & 0 & 0 & 1 & 1 \\ 1 & 1 & 1 & 1 & 0 & 0 & 0 & 0 \\ 0 & 0 & 0 & 0 & 1 & 1 & 1 & 1 \\ 0 & 1 & 0 & 1 & 0 & 0 & 0 & 0 \\ 0 & 0 & 0 & 0 & 0 & 1 & 0 & 1\end{matrix} ] \cdot [ \begin{matrix}{d}_{1} \\ {d}_{2} \\ {d}_{3} \\ {d}_{4} \\ {d}_{5} \\ {d}_{6} \\ {d}_{7} \\ {d}_{8}\end{matrix} ] , \qquad Eq ( 10 )$$

where d₁, d₂, . . . , d₈ are eight coefficients for the block-to-mesh domain transformation.

Equation (10) has the same form as equation (3). However, in the matrix to the right of the equality, the coordinates of the four mesh vertices in equation (3) are replaced with the coordinates of the four block vertices in equation (10), so that (u₁,v₁)=(0,0) replaces (x₁,y₁), (u₂,v₂)=(0,1) replaces (x₂,y₂), (u₃,v₃)=(1,1) replaces (x₃,y₃), and (u₄,v₄)=(1,0) replaces (x₄,y₄). Furthermore, the vector of coefficients a₁, a₂, . . . , a₈ in equation (3) is replaced with the vector of coefficients d₁, d₂, . . . , d₈ in equation (10). Equation (10) maps the unit square block to the mesh using coefficients d₁, d₂, . . . , d₈.

Equation (10) may be expressed in matrix form as follows:

y=S·d. Eq (11)

where y is an 8×1 vector of coordinates for the four vertices of the mesh,
S is an 8×8 matrix to the right of the equality in equation (10), and
d is an 8×1 vector of coefficients for the block-to-mesh domain transformation.

The domain transformation coefficients d may be obtained as follows:

d=S⁻¹·x, Eq (12)

where matrix S⁻¹ may be computed once and used for all meshes.

The block-to-mesh domain transformation may be performed as follows:

$$[ \begin{matrix}x \\ y\end{matrix} ] = [ \begin{matrix}{d}_{1} & {d}_{2} & {d}_{3} & {d}_{4} \\ {d}_{5} & {d}_{6} & {d}_{7} & {d}_{8}\end{matrix} ] \cdot [ \begin{matrix}uv \\ u \\ v \\ 1\end{matrix} ] . \qquad Eq ( 13 )$$

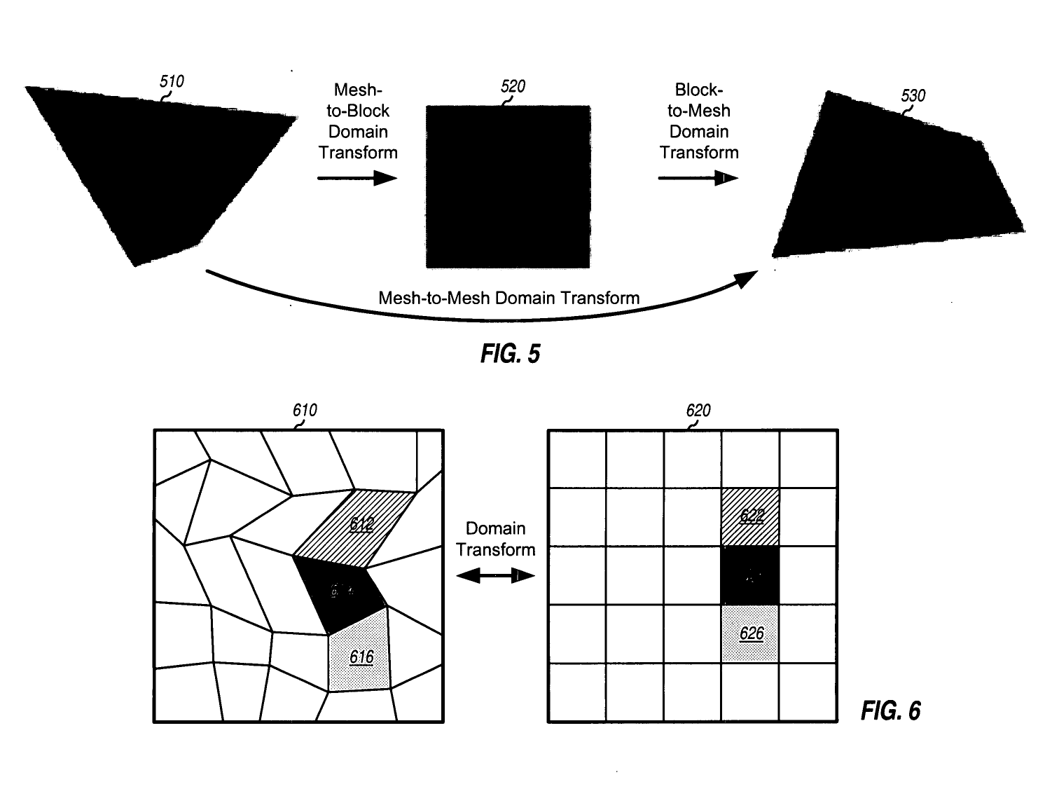

FIG. 5 illustrates domain transformations between two meshes and a block. A mesh 510 may be mapped to a block 520 based on equation (9). Block 520 may be mapped to a mesh 530 based on equation (13). Mesh 510 may be mapped to mesh 530 based on equation (2). The coefficients for these domain transformations may be determined as described above.

FIG. 6 shows domain transformation performed on all meshes of a frame 610. In this example, meshes 612, 614 and 616 of frame 610 are mapped to blocks 622, 624 and 626, respectively, of a frame 620 using mesh-to-block domain transformation. Blocks 622, 624 and 626 of frame 620 may also be mapped to meshes 612, 614 and 616, respectively, of frame 610 using block-to-mesh domain transformation.

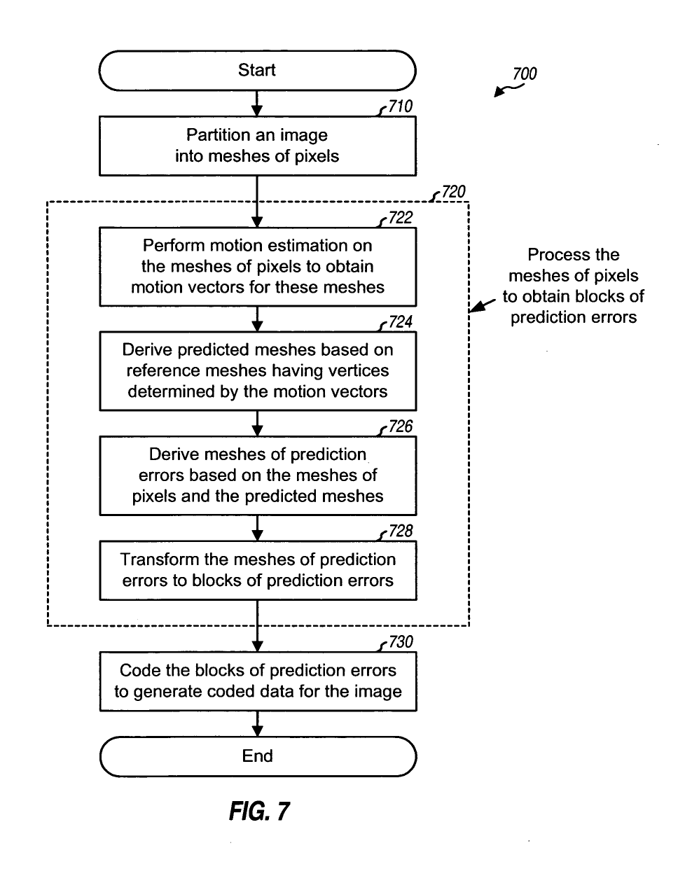

FIG. 7 shows an embodiment of a process 700 for performing mesh-based video compression with domain transformation. An image is partitioned into meshes of pixels (block 710). The meshes of pixels are processed to obtain blocks of prediction errors (block 720). The blocks of prediction errors are coded to generate coded data for the image (block 730).

The meshes of pixels may be processed to obtain meshes of prediction errors, which may be domain transformed to obtain the blocks of prediction errors. Alternatively, the meshes of pixels may be domain transformed to obtain blocks of pixels, which may be processed to obtain the blocks of prediction errors. In an embodiment of block 720, motion estimation is performed on the meshes of pixels to obtain motion vectors for these meshes (block 722). The motion estimation for a mesh of pixels may be performed by (1) estimating translational motion of the mesh of pixels and (2) estimating other types of motion by varying one vertex at a time over a search space while keeping remaining vertices fixed. Predicted meshes are derived based on reference meshes having vertices determined by the motion vectors (block 724). Meshes of prediction errors are derived based on the meshes of pixels and the predicted meshes (block 726). The meshes of prediction errors are domain transformed to obtain the blocks of prediction errors (block 728).

Each mesh may be a quadrilateral having an arbitrary shape, and each block may be a square of a predetermined size. The meshes may be transformed to blocks in accordance with bilinear transform. A set of coefficients may be determined for each mesh based on the vertices of the mesh, e.g., as shown in equations (6) through (8). Each mesh may be transformed to a block based on the set of coefficients for that mesh, e.g., as shown in equation (9).

The coding may include (a) performing DCT on each block of prediction errors to obtain a block of DCT coefficients and (b) performing entropy coding on the block of DCT coefficients. A metric may be determined for each block of prediction errors, and the block of prediction errors may be coded if the metric exceeds a threshold. The coded blocks of prediction errors may be used to reconstruct the meshes of prediction errors, which may in turn be used to reconstruct the image. The reconstructed image may be used for motion estimation of another image.

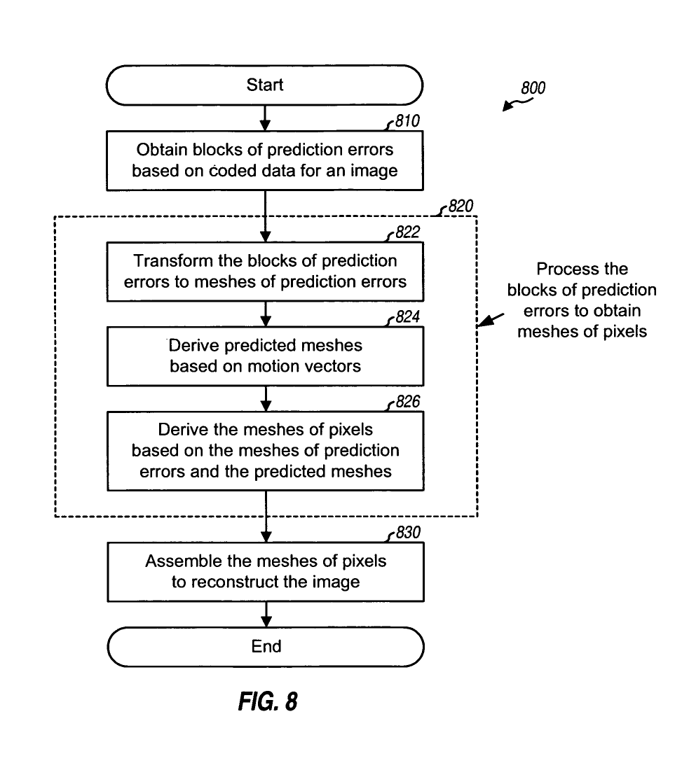

FIG. 8 shows an embodiment of a process 800 for performing mesh-based video decompression with domain transformation. Blocks of prediction errors are obtained based on coded data for an image (block 810). The blocks of prediction errors are processed to obtain meshes of pixels (block 820). The meshes of pixels are assembled to reconstruct the image (block 830).

In an embodiment of block 820, the blocks of prediction errors are domain transformed to meshes of prediction errors (block 822), predicted meshes are derived based on motion vectors (block 824), and the meshes of pixels are derived based on the meshes of prediction errors and the predicted meshes (block 826). In another embodiment of block 820, predicted blocks are derived based on motion vectors, the blocks of pixels are derived based on the blocks of prediction errors and the predicted blocks, and the blocks of pixels are domain transformed to obtain the meshes of pixels. In both embodiments, a reference mesh may be determined for each mesh of pixels based on the motion vectors for that mesh of pixels. The reference mesh may be domain transformed to obtain a predicted mesh or block. The block-to-mesh domain transformation may be achieved by (1) determining a set of coefficients for a block based on the vertices of a corresponding mesh and (2) transforming the block to the corresponding mesh based on the set of coefficients.

The video compression/decompression techniques described herein may provide improved performance. Each frame of video may be represented with meshes. The video may be treated as continuous affine or perspective transformation of each mesh from one frame to the next. Affine transformation includes translation, rotation, scaling, and shearing, and perspective transformation additionally includes perspective warping. One advantage of mesh-based video compression is flexibility and accuracy of motion estimation. A mesh is no longer restricted to only translational motion and may instead have the general and realistic type of affine/perspective motion. With affine transformation, the pixel motion inside each mesh is a bilinear interpolation or first-order approximation of motion vectors for the mesh vertices. In contrast, the pixel motion inside each block or sub-block is a nearest neighbor or zero-order approximation of motion at the vertices or center of the block/sub-block in the block-based approach.

Mesh-based video compression may be able to model motion more accurately than block-based video compression. The more accurate motion estimation may reduce temporal redundancy of video. Thus, coding of prediction errors (texture) may not be needed in certain cases. The coded bit stream may be dominated by a sequence of mesh frames with occasional update of intra-frames (I-frames).

Another advantage of mesh-based video compression is inter-frame interpolation. A virtually unlimited number of in-between frames may be created by interpolating the mesh grids of adjacent frames, generating so-called frame-free video. Mesh grid interpolation is smooth and continuous, producing little artifacts when the meshes are accurate representations of a scene.

The domain transformation provides an effective way to handle prediction errors (textures) for meshes with irregular shapes. The domain transformation also allows for mapping of meshes for I-frames (or intra-meshes) to blocks. The blocks for texture and intra-meshes may be efficiently coded using various block-based coding tools available in the art.

The video compression/decompression techniques described herein may be used for communication, computing, networking, personal electronics, etc. An exemplary use of the techniques for wireless communication is described below.

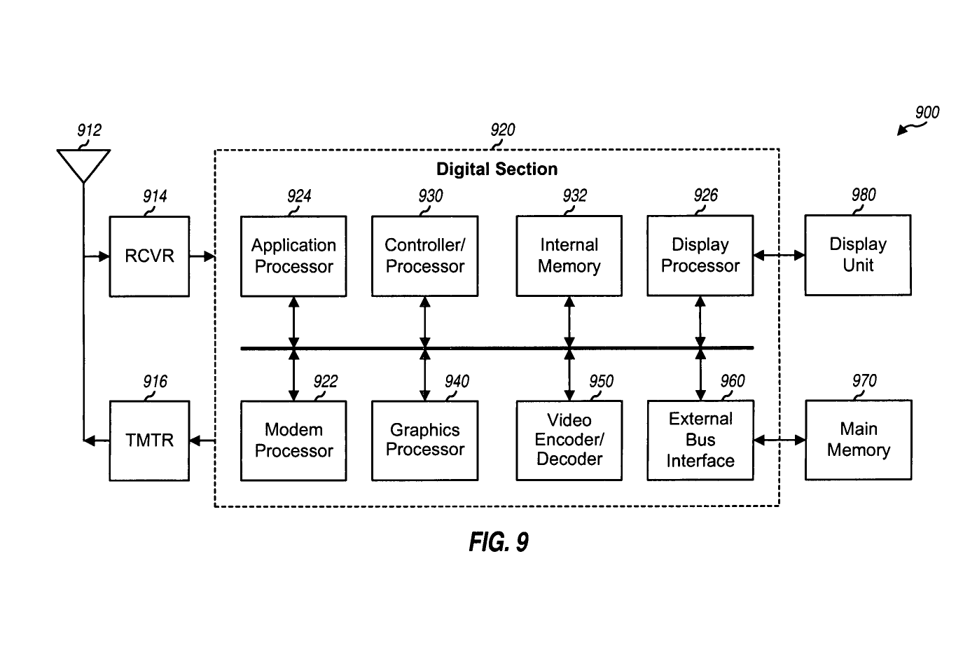

FIG. 9 shows a block diagram of an embodiment of a wireless device 900 in a wireless communication system. Wireless device 900 may be a cellular phone, a terminal, a handset, a personal digital assistant (PDA), or some other device. The wireless communication system may be a Code Division Multiple Access (CDMA) system, a Global System for Mobile Communications (GSM) system, or some other system.

Wireless device 900 is capable of providing bi-directional communication via a receive path and a transmit path. On the receive path, signals transmitted by base stations are received by an antenna 912 and provided to a receiver (RCVR) 914. Receiver 914 conditions and digitizes the received signal and provides samples to a digital section 920 for further processing. On the transmit path, a transmitter (TMTR) 916 receives data to be transmitted from digital section 920, processes and conditions the data, and generates a modulated signal, which is transmitted via antenna 912 to the base stations.

Digital section 920 includes various processing, memory, and interface units such as, for example, a modem processor 922, an application processor 924, a display processor 926, a controller/processor 930, an internal memory 932, a graphics processor 940, a video encoder/decoder 950, and an external bus interface (EBI) 960. Modem processor 922 performs processing for data transmission and reception, e.g., encoding, modulation, demodulation, and decoding. Application processor 924 performs processing for various applications such as multi-way calls, web browsing, media player, and user interface. Display processor 926 performs processing to facilitate the display of videos, graphics, and texts on a display unit 980. Graphics processor 940 performs processing for graphics applications. Video encoder/decoder 950 performs mesh-based video compression and decompression and may implement video encoder 100 in FIG. 1 for video compression and video decoder 200 in FIG. 2 for video decompression. Video encoder/decoder 950 may support video applications such as camcorder, video playback, video conferencing, etc.

Controller/processor 930 may direct the operation of various processing and interface units within digital section 920. Memories 932 and 970 store program codes and data for the processing units. EBI 960 facilitates transfer of data between digital section 920 and a main memory 970.

Digital section 920 may be implemented with one or more digital signal processors (DSPs), micro-processors, reduced instruction set computers (RISCs), etc. Digital section 920 may also be fabricated on one or more application specific integrated circuits (ASICs) or some other type of integrated circuits (ICs).

The video compression/decompression techniques described herein may be implemented by various means. For example, these techniques may be implemented in hardware, firmware, software, or a combination thereof. For a hardware implementation, the processing units used to perform video compression/decompression may be implemented within one or more ASICs, DSPs, digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the techniques may be implemented with modules (e.g., procedures, functions, etc.) that perform the functions described herein. The firmware and/or software codes may be stored in a memory (e.g., memory 932 and/or 970 in FIG. 9) and executed by a processor (e.g., processor. 930). The memory may be implemented within the processor or external to the processor.

The previous description of the disclosed embodiments is provided to enable any person skilled in the art to make or use the disclosure. Various modifications to these embodiments will be readily apparent to those skilled in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What is claimed is:

1. An apparatus comprising:
at least one processor configured to partition an image into meshes of pixels, to process the meshes of pixels to obtain blocks of prediction errors, and to code the blocks of prediction errors to generate coded data for the image; and
a memory coupled to the at least one processor.

2. The apparatus of claim 1, wherein each mesh is a quadrilateral having an arbitrary shape, and wherein each block is a square of a predetermined size.

3. The apparatus of claim 1, wherein the at least one processor is configured to process the meshes of pixels to obtain meshes of prediction errors and to transform the meshes of prediction errors to the blocks of prediction errors.

4. The apparatus of claim 1, wherein the at least one processor is configured to transform the meshes of pixels to blocks of pixels and to process the blocks of pixels to obtain the blocks of prediction errors.

5. The apparatus of claim 1, wherein the at least one processor is configured to transform the meshes to the blocks in accordance with bilinear transform.

6. The apparatus of claim 1, wherein the at least one processor is configured to determine a set of coefficients for each mesh based on vertices of the mesh and to transform each mesh to a block based on the set of coefficients for the mesh.

7. The apparatus of claim 1, wherein the at least one processor is configured to perform motion estimation on the meshes of pixels to obtain motion vectors for the meshes of pixels.

8. The apparatus of claim 7, wherein the at least one processor is configured to derive predicted meshes based on the motion vectors and to determine prediction errors based on the meshes of pixels and the predicted meshes.

9. The apparatus of claim 1, wherein for each mesh of pixels the at least one processor is configured to determine a reference mesh having vertices determined by estimated motion of the mesh of pixels and to derive a mesh of prediction errors based on the mesh of pixels and the reference mesh.

10. The apparatus of claim 9, wherein the at least one processor is configured to determine the reference mesh by estimating translational motion of the mesh of pixels.

11. The apparatus of claim 9, wherein the at least one processor is configured to determine the reference mesh by varying one vertex at a time over a search space while keeping remaining vertices fixed.

12. The apparatus of claim 1, wherein for each block of prediction errors the at least one processor is configured to determine a metric for the block of prediction errors and to code the block of prediction errors if the metric exceeds a threshold.

13. The apparatus of claim 1, wherein for each block of prediction errors the at least one processor is configured to perform discrete cosine transform (DCT) on the block of prediction errors to obtain a block of DCT coefficients, and to perform entropy coding on the block of DCT coefficients.

14. The apparatus of claim 1, wherein the at least one processor is configured to reconstruct meshes of prediction errors based on coded blocks of prediction errors, to reconstruct the image based on the reconstructed meshes of prediction errors, and to use the reconstructed image for motion estimation.

15. The apparatus of claim 14, wherein the at least one processor is configured to determine a set of coefficients for each coded block of prediction errors based on vertices of a corresponding reconstructed mesh of prediction errors, and to transform each coded block of prediction errors to the corresponding reconstructed mesh of prediction errors based on the set of coefficients for the coded block.

16. The apparatus of claim 1, wherein the at least one processor is configured to partition a second image into second meshes of pixels, to transform the second meshes of pixels to blocks of pixels, and to code the blocks of pixels to generate coded data for the second image.

17. A method comprising:
partitioning an image into meshes of pixels;
processing the meshes of pixels to obtain blocks of prediction errors; and
coding the blocks of prediction errors to generate coded data for the image.

18. The method of claim 17, wherein the processing the meshes of pixels comprises
processing the meshes of pixels to obtain meshes of prediction errors, and
transforming the meshes of prediction errors to the blocks of prediction errors.

19. The method of claim 17, wherein the processing the meshes of pixels comprises
transforming the meshes of pixels to blocks of pixels, and
processing the blocks of pixels to obtain the blocks of prediction errors.

20. The method of claim 17, wherein the processing the meshes of pixels comprises
determining a set of coefficients for each mesh based on vertices of the mesh, and
transforming each mesh to a block based on the set of coefficients for the mesh.

21. An apparatus comprising:
means for partitioning an image into meshes of pixels;
means for processing the meshes of pixels to obtain blocks of prediction errors; and
means for coding the blocks of prediction errors to generate coded data for the image.

22. The apparatus of claim 21, wherein the means for processing the meshes of pixels comprises
means for processing the meshes of pixels to obtain meshes of prediction errors, and
means for transforming the meshes of prediction errors to the blocks of prediction errors.

23. The apparatus of claim 21, wherein the means for processing the meshes of pixels comprises
means for transforming the meshes of pixels to blocks of pixels, and
means for processing the blocks of pixels to obtain the blocks of prediction errors.

24. The apparatus of claim 21, wherein the means for processing the meshes of pixels comprises
means for determining a set of coefficients for each mesh based on vertices of the mesh, and
means for transforming each mesh to a block based on the set of coefficients for the mesh.

25. An apparatus comprising:
at least one processor configured to obtain blocks of prediction errors based on coded data for an image, to process the blocks of prediction errors to obtain meshes of pixels, and to assemble the meshes of pixels to reconstruct the image; and
a memory coupled to the at least one processor.

26. The apparatus of claim 25, wherein the at least one processor is configured to transform the blocks to the meshes in accordance with bilinear transform.

27. The apparatus of claim 25, wherein the at least one processor is configured to determine a set of coefficients for each block based on vertices of a corresponding mesh, and to transform each block to the corresponding mesh based on the set of coefficients for the block.

28. The apparatus of claim 25, wherein the at least one processor is configured to transform the blocks of prediction errors to meshes of prediction errors, to derive predicted meshes based on motion vectors, and to derive the meshes of pixels based on the meshes of prediction errors and the predicted meshes.

29. The apparatus of claim 28, wherein the at least one processor is configured to determine reference meshes based on the motion vectors and to transform the reference meshes to the predicted meshes.

30. The apparatus of claim 25, wherein the at least one processor is configured to derive predicted blocks based on motion vectors, to derive blocks of pixels based on the blocks of prediction errors and the predicted blocks, and to transform the blocks of pixels to the meshes of pixels.

31. A method comprising:
obtaining blocks of prediction errors based on coded data for an image;
processing the blocks of prediction errors to obtain meshes of pixels; and
assembling the meshes of pixels to reconstruct the image.

32. The method of claim 31, wherein the processing the blocks of prediction errors comprises
determining a set of coefficients for each block based on vertices of a corresponding mesh, and
transforming each block to the corresponding mesh based on the set of coefficients for the block.

33. The method of claim 31, wherein the processing the blocks of prediction errors comprises
transforming the blocks of prediction errors to meshes of prediction errors,
deriving predicted meshes based on motion vectors, and
deriving the meshes of pixels based on the meshes of prediction errors and the predicted meshes.

34. The method of claim 31, wherein the processing the blocks of prediction errors comprises
deriving predicted blocks based on motion vectors,
deriving blocks of pixels based on the blocks of prediction errors and the predicted blocks, and
transforming the blocks of pixels to the meshes of pixels.

35. An apparatus comprising:
means for obtaining blocks of prediction errors based on coded data for an image;
means for processing the blocks of prediction errors to obtain meshes of pixels; and
means for assembling the meshes of pixels to reconstruct the image.

36. The apparatus of claim 35, wherein the means for processing the blocks of prediction errors comprises
means for determining a set of coefficients for each block based on vertices of a corresponding mesh, and
means for transforming each block to the corresponding mesh based on the set of coefficients for the block.

37. The apparatus of claim 35, wherein the means for processing the blocks of prediction errors comprises
means for transforming the blocks of prediction errors to meshes of prediction errors,
means for deriving predicted meshes based on motion vectors, and
means for deriving the meshes of pixels based on the meshes of prediction errors and the predicted meshes.

38. The apparatus of claim 35, wherein the means for processing the blocks of prediction errors comprises
means for deriving predicted blocks based on motion vectors,
means for deriving blocks of pixels based on the blocks of prediction errors and the predicted blocks, and
means for transforming the blocks of pixels to the meshes of pixels.
